(19) United States
(12) Patent Application Publication
(10) Pub. No.: US 2013/0283887 A1
(43) Pub. Date: Oct. 31, 2013

(54) METHOD FOR OPERATING A SOOT SENSOR

(71) Applicants: Johannes Ante, Regensburg (DE); Markus Herrmann, Regensburg (DE); Andreas Ott, Steinsberg (DE); Willibald Reitmerier, Hohenschambach (DE); Denny Schädlich, Neustadt (DE); Manfred Weigl, Sinzing/Viehhausen (DE); Andreas Wildgen, Nittendorf (DE)

(72) Inventors: Johannes Ante, Regensburg (DE); Markus Herrmann, Regensburg (DE); Andreas Ott, Steinsberg (DE); Willibald Reitmerier, Hohenschambach (DE); Denny Schädlich, Neustadt (DE); Manfred Weigl, Sinzing/Viehhausen (DE); Andreas Wildgen, Nittendorf (DE)

(21) Appl. No.: 13/994,056

(22) PCT Filed: Dec. 14, 2011
(86) PCT No.: PCT/EP2011/072778

§ 371 Date: Jun. 13, 2013

(30) Foreign Application Priority Data
Dec. 15, 2010 (DE) 10 2010 054 671.2

(51) Int. Cl. G01N 15/06

(52) U.S. Cl. CPC G01N 15/0656
USPC 73/28.01

(57) ABSTRACT

A method for operating a soot sensor in the exhaust gas tract of an internal combustion engine. The soot sensor includes an inter-digital electrode structure to which a measurement voltage is applied. Soot particles from the exhaust gas flow deposit themselves on the inter-digital electrode structure and an measuring current is evaluated as a measurement for the soot concentration of the soot sensor. A heating element for burning clean the inter-digital electrode structure is provided. The method for operating the soot sensor has good measurement results and the shortest possible idle time. To this end, a point in time for burning clean the soot sensor is determined in accordance with the operational state of the internal combustion engine and then, the burning clean of the inter-digital electrode structure starts by heating the soot sensor by the heating element.

### CROSS REFERENCE TO RELATED APPLICATIONS

This is a U.S. national stage of application No. PCT/EP2011/072778, filed on 14 Dec. 2011. Priority is claimed on German Application No.: 10 2010 054 671.2 filed 15 Dec. 2010 the content of which is incorporated here by reference.

### BACKGROUND OF THE INVENTION

1. Field of the Invention

The invention relates to a method for operating a carbon particulate sensor in the exhaust gas tract of an internal combustion engine. The carbon particulate sensor comprises an interleaved finger electrode structure to which a measuring voltage is applied. Carbon particulates from an exhaust gas flow deposit themselves on the interleaved finger electrode structure and the measuring current that flows over the carbon particulates and the interleaved finger electrode structure is evaluated as a measurement for the carbon particulate concentration of the carbon particulate sensor. The carbon particulate sensor comprises a heating element for burning clean the interleaved finger electrode structure.

2. Description of the Prior Art

Internal combustion engines in terms of this patent application are all engines in which a fuel-oxygen mixture is combusted, whereby mechanical energy is released. This patent application relates primarily to diesel engines since these engines in particular are inclined to develop carbon particulate emissions but this patent application also relates to gasoline-driven or gas-driven internal combustion engines.

The increased concentration in the atmosphere of pollutants from exhaust gases is currently frequently discussed. These discussions are associated with the fact that the availability of fossil energy carriers is limited. In response thereto, for example, combustion processes in internal combustion engines are thermo-dynamically optimized so that their efficiency level is improved. This is reflected in the automobile field in the increasing use of diesel engines. However, the disadvantage of this combustion engineering in comparison to optimized Otto engines is a considerably higher emission of carbon particulates. Carbon particulates are extremely carcinogenic particularly as a result of the concentration of polycyclic aromatic hydrocarbons and various regulations have already been introduced in response to this. Thus, for example, exhaust gas emission standards that dictate maximum limits for the carbon particulate emission have been issued. It has therefore become necessary to provide cost-effective sensors that measure, in a reliable manner, the carbon particulate concentration in the exhaust gas flow of motor vehicles.

Carbon particulate sensors of this type are used to measure the actual amount of carbon particulates that are discharged with the exhaust gas flow so that information relating to the prevailing driving situation is available to the engine management system in an automobile to reduce the emission values by adjustments relating to control engineering. In addition, it is possible with the aid of carbon particulate sensors to initiate an active treatment of exhaust gases using exhaust gas carbon particulate filters or the exhaust gas can be returned to the internal combustion engine. The process of filtering the carbon particulates involves the use of filters that can be regenerated and that filter out a considerable part of the carbon particulate concentration from the exhaust gas. However, carbon particulate sensors are required to detect the carbon particulates to monitor the function of the carbon particulate filters and to control the regeneration cycles of said filters.

For this purpose, it is possible to connect a carbon particulate sensor upstream of the carbon particulate filter that is also referred to as a diesel particulate filter and/or to connect a carbon particulate sensor downstream of said carbon particulate filter.

The sensor that is connected upstream of the diesel particulate filter is used to increase the safety of the system and to ensure a safe and reliable operation of the diesel particulate filter under optimum conditions. Since this depends to a great extent upon the quantity of carbon particulates that are deposited in the diesel particulate filter, it is extremely important to obtain a precise measurement of the particulate concentration upstream of the diesel particulate filter system and in particular to ascertain if there is a high carbon particulate concentration upstream of the diesel particulate filter.

A sensor that is connected downstream of the diesel particulate filter provides the ability to perform an on-board diagnosis and moreover said sensor is used to ensure the correct operation of the exhaust gas treatment system.

Various approaches for detecting carbon particulates are available in the prior art. One approach that continues to be studied in laboratories is the use of light dispersion through the carbon particulates. This method is suitable for costly measuring devices. However, when attempts are made to also use this method as a mobile sensor system in the exhaust gas tract, it has been established that approaches of this type for providing a sensor in a motor vehicle are encumbered by high costs as a result of the expensive optical structure. Furthermore, the problems relating to the necessary optical windows being contaminated by combustion gases have not yet been solved.

The unexamined German application DE 199 59 871 A1 discloses a sensor and an operating method for the sensor, wherein both the sensor and the operating method are based on thermal considerations. The sensor comprises an open porous molded body, for example a honey-combed ceramic body, a heating element and a temperature sensor. If the sensor is brought into contact with a measuring gas volume, the carbon particulates are deposited thereon. To perform the measurement, the carbon particulates that have been deposited over a period of time are ignited with the aid of the heating element and burned. The increase in temperature that occurs during the burning process is measured.

Particulate sensors for conductive particles are currently known; said sensors comprise two or more metal electrodes that engage one with the other in a mesh-like manner. These mesh-like structures are also described as interleaved finger structures. Carbon particulates that are deposited on these sensor structures short-circuit the electrodes and consequently change the impedance of the electrode structure. As the concentration of particulates on the sensor surface increases, it is possible in this manner to measure a decreasing resistance and/or an increasing current in the presence of a constant voltage between the electrodes. A carbon particulate sensor of this type is disclosed for example in DE 10 2004 028 997 A1. However, in order to be able to measure a current between the electrodes, a specific quantity of carbon particulates must be available between the electrodes. The carbon particulate sensor is to a certain extent blind to the carbon particulate concentration in the exhaust gas flow unless the concentration has achieved this minimum level of carbon particulate deposits.

In addition, the carbon particulate sensor needs to be cleaned at regular intervals. The sensor is regenerated by burning off the deposited carbon particulates. This process is also described as burning clean the interleaved finger electrode structure. In order to regenerate the sensor element, the carbon particulates are generally burnt off said sensor element with the aid of an integrated heating element after the carbon particulates have been deposited. During the burn-clean phase the sensor is unable to sense the concentration of carbon particulates in the exhaust gas flow. The time required for the sensor structure to be regenerated by the burn-clean method is also described as a down time of the sensor. It is therefore important to be able to maintain the burn-clean phase and the subsequent phase of reconditioning the carbon particulate sensor as short as possible, in order to be able to use the carbon particulate sensor as quickly as possible for performing further carbon particulate measurements.

### SUMMARY OF THE INVENTION

An object of the invention is a method for operating a carbon particulate sensor that delivers meaningful measurement results, wherein the carbon particulate sensor is to comprise as short as possible down times.

Based on the fact that a point in time at which the carbon particulate sensor is to be burned clean is ascertained in dependence upon the operating status of the internal combustion engine and the process of burning clean the interleaved finger electrode structure then commences by heating the carbon particulate sensor using the heating element, it is possible to select and use in a purposeful manner such times for the process of burning off the carbon particulates during which it would in any case not be expedient or not possible to measure the carbon particulate concentration. The carbon particulate concentration in the exhaust gas flow of a motor vehicle can then be effectively measured using the method in accordance with one embodiment the invention if this measurement provides meaningful results based on the operating status of the internal combustion engine, as a consequence of which it is possible to considerably reduce the emission of pollutants. An operating status of the internal combustion engine, in dependence upon which a point in time is ascertained at which the carbon particulate sensor is to be burned clean, can be for example the crankshaft rotational speed of the internal combustion engine and/or the temperature of the internal combustion engine, in particular the temperature of its cooling elements.

A further embodiment of the invention is characterized by virtue of the fact that the point in time at which the carbon particulate sensor is burned clean is the time at which the internal combustion engine is restarted. A restart of the internal combustion engine can be detected for example by observing the crankshaft rotational speed. If the internal combustion engine is restarted, then the process of burning clean the interleaved finger electrode structure by heating the carbon particulate sensor using the heating element is also commenced. It is not expedient in this operating mode to perform the carbon particulate measuring procedure and therefore the process of burning clean the interleaved finger electrode structure is not at the expense of the measuring time.

In one embodiment of the invention, the point in time at which the carbon particulate sensor is burned clean is the time at which the completely cooled internal combustion engine is restarted. In the case of a completely cooled internal combustion engine, conditions that render it almost impossible to measure the carbon particulate concentration prevail in the exhaust gas tract. It is only expedient to measure the carbon particulate concentration in the exhaust gas flow once a thermal equilibrium has been established between the hot exhaust gas and the carbon particulate sensor. The period of time until this thermal equilibrium is established between the hot exhaust gas and the carbon particulate sensor can be expediently used for cleaning, in other words for burning off carbon particulates from the interleaved finger electrode structure of the carbon particulate sensor. However, consideration is to be given to the dew point release by the carbon particulate sensor.

The time at which the dew point release of the carbon particulate sensor is achieved is also very suitable as a point in time to start the process of burning clean the carbon particulate sensor. Up to a particular temperature in the exhaust gas tract the exhaust gas does not contain any water droplets that could condense on a cold carbon particulate sensor. If the carbon particulate sensor is heated under these conditions, then the condensed water can lead to the interleaved finger electrode structure being damaged.

A good point in time to initiate the process of burning clean the carbon particulate sensor is also after the internal combustion engine has been switched off. In order to regenerate the carbon particulate sensor by the burning-clean process it is possible, particularly in the case of modern vehicles having internal combustion engines with an automatic start/stop system, to use extremely efficiently the period of time during which the internal combustion engine is not operating during a vehicle stop, for example at a red light. The operating status of the non-operating internal combustion engine can, for example, be detected in an extremely easy manner with the aid of a sensor that monitors the rotational speed of the crankshaft.

In one embodiment of the invention, the point in time at which the carbon particulate sensor is burned clean is within the period of time during which the diesel particulate filter is regenerated. The exhaust gas is already extremely hot during the regeneration of the diesel particulate filter. Therefore, only a small amount of electrical energy is required for the intrinsic heating of the carbon particulate sensor.

In one embodiment, the point in time at which the carbon particulate sensor is burned clean is achieved in the case of a full-load operation of the internal combustion engine. In this operating status, the exhaust gas is already extremely hot and therefore only a small amount of electrical energy is required for the intrinsic heating of the carbon particulate sensor.

However, it is also advantageous if the point in time at which the carbon particulate sensor is burned clean is achieved during low load points of the internal combustion engine. In the case of a low load, the amount of carbon particulate slipping through a possibly damaged diesel particulate filter is small. There is hardly any increase in a signal at the sensor and no data is lost as a result of burning clean the carbon particulate sensor.

### BRIEF DESCRIPTION OF THE DRAWINGS

The invention is explained hereinunder with reference to the figures. The following drawings show in:

FIG. 1 is a carbon particulate sensor;

FIG. 2 is an operational method of the carbon particulate sensor;

FIG. 3 is a control device that is fixedly installed in a motor vehicle and is configured to operate a carbon particulate sensor;

FIG. 4 is a motor vehicle having an internal combustion engine; and

FIG. 5 a flowchart of the method in accordance with the invention.

### DETAILED DESCRIPTION OF THE PREFERRED EMBODIMENTS

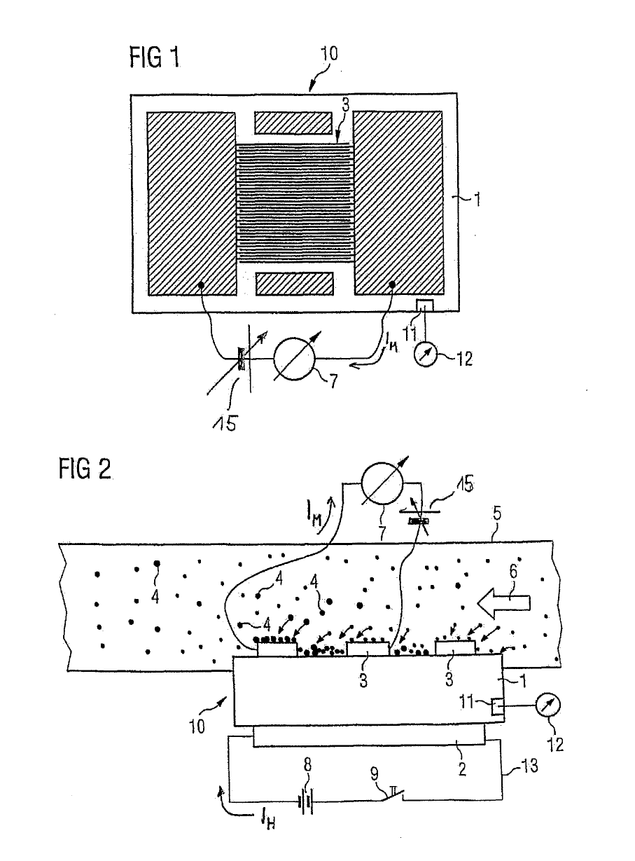

FIG. 1 illustrates a carbon particulate sensor 10 that is embodied from a molded body 1, a heating element 2, and a structure of measuring electrodes 3 that engage one with the other in an interleaved finger manner. The molded body 1 can be produced from a ceramic material or can be embodied from a different material that comprises electrically insulating properties and resists the temperatures involved when burning off carbon particulates 4. In order to burn off the carbon particulates 4 from the carbon particulate sensor 10, the carbon particulate sensor 10 is heated to temperatures between 500° C. and 800° C. in a typical manner with the aid of an electrical resistance heater. The electrically insulating molded body 1 must be able to withstand these temperatures without being damaged. The structure of the measuring electrodes 3 is embodied in this case by way of example as a mesh-like structure that is also described as an interleaved finger electrode structure 3, wherein an electrically insulating region of the molded body 1 is always to be seen between two measuring electrodes 3. The measuring electrodes 3 and the intermediate spaces between the measuring electrodes 3 form the interleaved finger electrode structure 3. However, it is also feasible that the interleaved finger electrode structure 3′ is embodied for example from annular measuring electrodes 3 that are arranged in a concentric manner.

The width of a measuring electrode 3 can, for example, be between 50 and 100 μm and the spacing between the individual measuring electrodes 3 can likewise amount to 50 and 100 μm. An interleaved finger electrode structure 3 having dimensions of this type can be easily produced using thick layer technology. Interleaved finger electrode structures 3 that are produced using thick layer technology are robust, have a long serviceable life and are cost-effective.

The measuring current I_{M} between the measuring electrodes 3 is measured with the aid of a current measuring element 7. As long as the carbon particulate sensor 10 is completely free of carbon particulates 4, the current measuring element 7 will be unable to measure any measuring current I_{M}, the reason being that there is always a region of the molded body 1 between the measuring electrodes 3, which region acts in an electrically insulating manner and is also not by-passed by carbon particulates 4.

Furthermore, FIG. 1 illustrates a temperature sensor 11 as a component of the carbon particulate sensor 10 having an electronic temperature evaluating unit 12 that is used to monitor the temperature prevailing in the carbon particulate sensor 10 primarily during the process of burning off the carbon particulate deposits from the interleaved finger electrode structure 3 of the carbon particulate sensor 10.

In addition, FIG. 1 illustrates a voltage source 15 that determines the voltage that is applied to the measuring electrodes 3. Measuring voltage can be applied to the measuring electrodes 3 by means of the voltage source 15.

FIG. 2 illustrates the method of operation of the carbon particulate sensor 10. In this case, the carbon particulate sensor 10 is arranged in an exhaust gas pipe 5 of a motor vehicle 16 and the exhaust gas flow that is charged with carbon particulates 4 is directed through said exhaust gas pipe 5. The flow direction of the exhaust gas flow 6 is indicated by the arrow. The task of the carbon particulate sensor 10 is to measure the concentration of the carbon particulates 4 in the exhaust gas flow 6. For this purpose, the carbon particulate sensor 10 is arranged in the exhaust gas pipe 5 such that the structure of measuring electrodes 3 that is arranged in an interleaved finger manner faces the exhaust gas flow 6 and consequently faces the carbon particulates 4. Carbon particulates 4 from the exhaust gas flow 6 deposit themselves both on the measuring electrodes 3 and also in the intermediate spaces between the measuring electrodes 3, in other words on the insulating regions of the molded body 1. If sufficient carbon particulates 4 have deposited themselves on the insulating region between the measuring electrodes 3, then as a result of the measuring voltage, which is applied to the measuring electrodes 3, and the conductive properties of the carbon particulates 4, a measuring current I_{H} flows between the measuring electrodes 3, which measuring current can be measured by the current measuring element 7. The carbon particulates 4 consequently by-pass the electrically insulating intermediate spaces between the measuring electrodes 3. In this manner, it is possible using the carbon particulate sensor 10, illustrated here, to measure the concentration of carbon particulates 4 in the exhaust gas flow 6.

In addition, the carbon particulate sensor 10 in FIG. 2 illustrates the heating element 2 that can be supplied with electrical heating current I_{H} from the heating current supply 8 by the heating current circuit 13. In order to heat the carbon particulate sensor 10 to the temperature required for burning off the carbon particulates 4, the heating current switch 9 is closed, as a consequence of which the heating current I_{H} heats up the heating element 2 and as a result the entire carbon particulate sensor 10 is heated. In addition, a temperature sensor 11 is integrated in the carbon particulate sensor 10, which temperature sensor 11 with the aid of the electronic temperature evaluating unit 12 checks and monitors the process of heating up the carbon particulate sensor 10 and consequently the process of burning off the carbon particulates 4, which process is also referred to as burning clean the carbon particulate sensor 10.

The current measuring element 7, the electronic temperature evaluating unit 12, the controllable voltage source 15, the temperature sensor 11 and the heating current switch 9 are represented here in an exemplary manner as separate components. Naturally, these components can be provided on a chip as components of a micro-mechanical system together with the interleaved finger electrode structure 3 or as components of a micro-electronic circuit that is integrated for example in a control device 14 for the carbon particulate sensor 10.

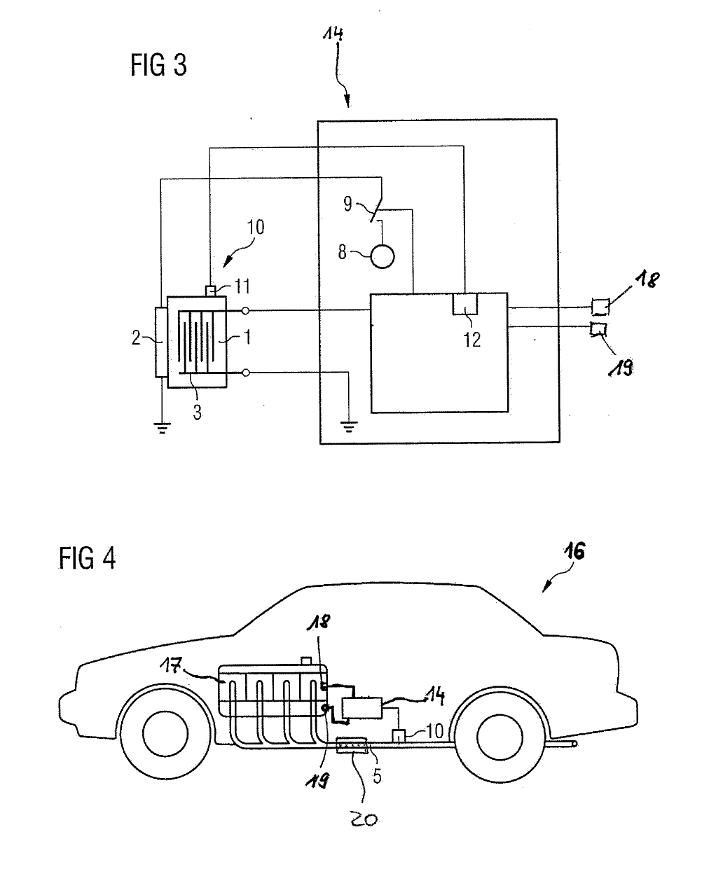

FIG. 3 illustrates a control device 14 that is fixedly installed in a motor vehicle 16 and is used for future-diagnosing, for operating, and for regenerating the carbon particulate sensor 10. The carbon particulate sensor 10 comprises a finger-like mutually engaging (interleaved finger) measuring electrode structure 3 that does not comprise any metal short circuits when the carbon particulate sensor 10 is intact. Carbon particulates 4 deposit themselves on and between the measuring electrodes 3 when the sensor is performing the measuring operation and said deposited carbon particulates 4 produce a current flow between the measuring electrodes 3 that is used as a measurement to indicate the carbon particulate concentration in the exhaust gas flow 6. However, when the concentration of deposited carbon particulates 4 on the measuring electrodes 3 is greater than a particular amount, a maximum conductivity is achieved over the carbon particulate layer and this maximum conductivity can also not be further increased as further carbon particulates 4 are deposited. The carbon particulate sensor 10 is therefore ‘blind’, in other words cannot perform a further measurement of the carbon particulate concentration in the exhaust gas 6 when the concentration of deposited carbon particulates 6 is above a particular amount. It is then necessary to regenerate the carbon particulate sensor 10 by burning off the carbon particulate layer on the interleaved finger measuring electrodes 3. For this purpose, a heating current is directed from the heating current supply 8 to the heating element 2 by virtue of switching on the heating current switch 9. The carbon particulate sensor 10 is monitored as it is heated up. The process of heating up the carbon particulate sensor 10 is monitored by the temperature sensor 11 that is embodied on or in the carbon particulate sensor 10. The process of burning clean the carbon particulate sensor 10 is performed based on the operating status of the internal combustion engine 17. The process of burning clean the carbon particulates is commenced at the point in time at which the operating status of the internal combustion engine 17 determines that it is not expedient to measure the carbon particulates 4. Consequently, the interleaved finger electrode structure 3 of the carbon particulate sensor 10 is cleaned precisely at a time when it would otherwise not be possible or expedient to measure the carbon particulates 4. The carbon particulate sensor 10 is also operational at points in time at which the carbon particulate concentration in the exhaust gas flow 6 can be measured, which renders it possible to continuously monitor the carbon particulate concentration in the exhaust gas flow 6. The operating status of the internal combustion engine 17 can be monitored for example using an internal combustion engine temperature sensor 18 that detects the temperature of the cooling fluid in the internal combustion engine 17 or the oil temperature and/or using a crankshaft rotational speed sensor 19 that detects the rotational speed of the crankshaft.

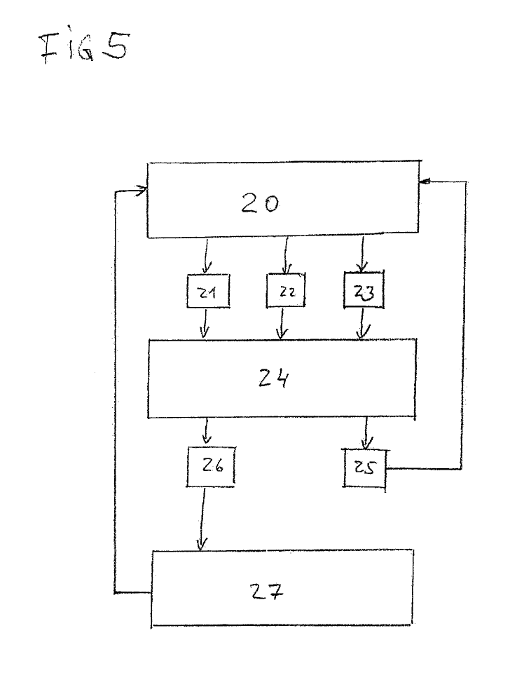

A motor vehicle 16 having an internal combustion engine 17 is represented in FIG. 4 in order to provide an overview of the entire system. The internal combustion engine 17 discharges the exhaust gas flow 6, which is generated by said internal combustion engine 17, by way of an exhaust gas pipe 5. A diesel particulate filter 20 is evident in the exhaust gas pipe 5. A carbon particulate sensor 10 is arranged in the exhaust gas pipe 5 upstream and/or downstream of the diesel particulate filter 20, which carbon particulate sensor is connected to a control device 14 that can also comprise the current measuring element 7. The crank shaft rotational speed sensor 19 and the internal combustion engine temperature sensor 18 provide the control device 14 with information relating to the operating status of the internal combustion engine 17. This information is used to select a point in time at which the process of burning off the carbon particulates 4 from the interleaved finger electrode structure 3 of the carbon particulate sensor is initiated. This point in time can be, for example, a restart of the internal combustion engine 17, which restart is recognized by the control device 14 with the aid of the crankshaft rotational speed sensor 19. The restart of the completely cooled internal combustion engine 17 is recognized by the control device 14 with the aid of the crankshaft rotational speed sensor 19 and the internal combustion engine temperature sensor 18. However, it is proposed to wait until the point in time of the dew point release of the carbon particulate sensor. The point in time at which the internal combustion engine 17 is switched off is in turn recognized with the aid of the crankshaft rotational speed sensor 19.

Numerous sensors that ascertain combustion-relevant and/or exhaust gas-relevant parameters are provided in the exhaust gas system of modern internal combustion engines 17. Said sensors are for example temperature sensors, oxygen sensors, sensors for ascertaining the fuel-air ratio Lambda, and nitrogen oxide sensors. Water vapor is present in the exhaust gas of an internal combustion engine 17. The water vapor condenses in the cold exhaust gas system, where it can form droplets of liquid water. Since liquid water can damage hot sensors, the sensors do not heat up or heat up only to a small extent following the restart of a cold engine and said sensors wait for the exhaust gas to be free of water. The sensors do not transmit any data to the engine control or only transmit the information “Sensor available, wait for permission to perform the measurement”.

The engine control of the internal combustion engine 17 uses the engine operating data and the measured temperatures to calculate the point in time after which it is expected that liquid water is no longer present at the sensor position, for example downstream of the catalytic convertor or the diesel particulate filter 20. If this point in time is achieved, the engine control transmits to the sensor a signal “Water is no longer present, measuring permission granted”. The sensor recognizes this signal and commences its heating process.

The information that the engine control transmits to the sensor “liquid water is no longer present at site A” is usually termed the dew point release A. If the sensor has been heated up and measurements taken prior to this point in time, then water droplets could damage the sensor. As far as the carbon particulate sensor 10 is concerned, the dew point release is at its position of the earliest possible point in time following the engine start after which the carbon particulate deposits can be burned off. In the case of a typical vehicle of the current type of construction, the dew point release occurs after a few minutes following an engine cold-start.

FIG. 5 illustrates the method in accordance with the invention for operating a carbon particulate sensor 10 in a flow chart. The operating status of the internal combustion engine 17 is monitored at point 20. The crankshaft rotational speed is monitored in step 21, the temperature of the internal combustion engine 17 is monitored in step 22 and the dew point release of the carbon particulate sensor 10 is monitored in step 23. A decision is made based at least in part on these steps as to whether to initiate the process of burning off the carbon particulate deposits from the interleaved finger electrode structure 3 of the carbon particulate sensor 10. The variables that are measured in steps 21, 22 and 23 can contribute individually or in combination with each other to the decision making process. For example, it is feasible that on the basis of monitoring the crankshaft rotational speed in step 21 the control device 14 recognizes that the internal combustion engine 17 has been restarted, and on the basis of the operation that is performed in step 22 of monitoring the temperature of the internal combustion engine 17 it is recognized that this restart of the internal combustion engine 17 was a cold start, in other words the internal combustion engine 17 was completely cooled at the time of the restart. These two criteria lead in step 24 to the procedure jumping to position 26 if the dew point release 23 is performed, wherein it is recognized as being expedient to burn off the carbon particulate deposits from the interleaved finger electrode structure 3, following which in step 27 the process of burning off the carbon particulate deposits from the interleaved finger electrode structure 3 of the carbon particulate sensor 10 is commenced. After the carbon particulates have been burned off the interleaved finger electrode structure 3, the procedure returns to step 20, in other words it returns to monitoring the operating status of the internal combustion engine 17.

However, it is also feasible that a decision is taken in step 24 based on a restart of the internal combustion engine 17 that would be recognized by virtue of monitoring the crankshaft rotational speed in step 21, in combination with a high temperature of the combustion engine 17 being recognized in step 22, a process of burning off the carbon particulates 4 is not to be initiated. This decision not to initiate the process of burning off the carbon particulates 4 from the interleaved finger electrode structure 3 is taken at point 25, following which the procedure is continued at point 20 with the monitoring of the operating status of the internal combustion engine 17.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-8. (canceled)

9. A method for operating a carbon particulate sensor in an exhaust gas tract of an internal combustion engine, wherein the carbon particulate sensor includes an interleaved finger electrode structure and a heating element configured to burn clean the interleaved finger electrode structure, the method comprising:
applying a measuring voltage to the interleaved finger electrode structure;
measuring a current that flows over carbon particulates from an exhaust gas flow that deposit themselves on the interleaved finger electrode structure;
evaluating the interleaved finger electrode structure as a measurement for carbon particulate concentration of the carbon particulate sensor;
ascertaining a point in time at which the carbon particulate sensor is to be burned clean based at least in part on an operating status of the internal combustion engine; and
commencing a process for burning clean the interleaved finger electrode structure by heating the carbon particulate sensor using the heating element.

10. The method for operating the carbon particulate sensor as claimed in claim 9, wherein the carbon particulate sensor is burned clean at a time at which the internal combustion engine is restarted.

11. The method for operating the carbon particulate sensor as claimed in claim 10, wherein the point in time the carbon particulate sensor is burned clean is when the completely cooled internal combustion engine is restarted.

12. The method for operating the carbon particulate sensor as claimed in claim 9, wherein the point in time the carbon particulate sensor is burned clean is when a dew point release of the carbon particulate sensor is achieved.

13. The method for operating the carbon particulate sensor as claimed in claim 9, wherein the point in time the carbon particulate sensor is burned clean is when the internal combustion engine is switched off.

14. The method for operating the carbon particulate sensor as claimed in claim 9, wherein the point in time the carbon particulate sensor is burned clean is within a period of time during which a diesel particulate filter is regenerated.

15. The method for operating the carbon particulate sensor as claimed in claim 9, wherein the point in time the carbon particulate sensor is burned clean is during a full-load operation of the internal combustion engine.

16. The method for operating the carbon particulate sensor as claimed in claim 9, wherein the point in time the carbon particulate sensor is burned clean during low load points of the internal combustion engine.
